(19) United States
(12) Patent Application Publication
(10) Pub. No.: US 2020/0160271 A1
(43) Pub. Date: May 21, 2020

(54) Collaboration Measurement and Database System

(71) Applicant: Microsoft Technology Licensing, LLC, Redmond, WA (US)

(72) Inventors: Chantrelle Nielsen, Seattle, WA (US); Nikolay Mitev Trandev, Bremerton, WA (US); Brett Daniel Mills, Seattle, WA (US); Dheepak Ramaswamy, Seattle, WA (US); Si Meng, Beijing (CN); Zoey Jennifer Geary, Seattle, WA (US); Mugdha Kolhatkar, Issaquah, WA (US); Pracheer Agarwal, Bengaluru (IN); Shubham Aggarwal, Bengaluru (IN); Tapas Bansal, Redmond, WA (US); Siddarth Rejendra Kumar, Bengaluru (IN); Abhishek Kalai Raghavendra, Bengaluru (IN); Jagadeesh Huliyar, Bengaluru (IN); Sanjay H. Ramaswamy, Redmond, WA (US); Sai Sumana Pagidipalli, Bengaluru (IN); Shubham Aggarwal, Bengaluru (IN); Sreeram Nivarthi, Redmond, WA (US)

(21) Appl. No.: 16/197,980

(22) Filed: Nov. 21, 2018

(51) Int. Cl. G06Q 10/10; G06F 17/30

(52) U.S. Cl. CPC G06Q 10/103; G06Q 10/1095; G06F 17/30312; G06F 17/30551

(57) ABSTRACT

A computer implemented method includes collecting collaboration information containing data representative of collaborations between at least two individuals, applying time allocation heuristics to the collected collaboration data to extract respective collaborations times for the at least two individuals, storing the extracted collaborations times on a storage device, and accessing the storage device to process queries regarding collaboration between the at least two individuals.

### BACKGROUND

Employees and groups in organizations collaborate with many other groups, both internally and externally. Collaborations, which necessary for organizations to survive and thrive, consume significant resources of organizations. While one may have an intuition for whether employees and groups of employees collaborate across the organization, or are they stuck in disparate silos, there are insufficient mechanisms to measure the amount and cost of such collaborations between each other internally or externally.

### SUMMARY

A computer implemented method includes collecting collaboration information containing data representative of collaborations between at least two individuals, applying time allocation heuristics to the collected collaboration data to extract respective collaborations times for the at least two individuals, storing the extracted collaborations times on a storage device, and accessing the storage device to process queries regarding collaboration between the at least two individuals.

### BRIEF DESCRIPTION OF THE DRAWINGS

FIG. 1 is a block diagram of an example collaboration measurement and database system according to an example embodiment.

FIG. 2 is a flowchart illustrating a computer implemented method of collecting, processing, and querying collaboration data according to an example embodiment.

FIG. 3 is a block diagram illustrating details of an example collaboration measurement and database system according to an example embodiment.

FIG. 4 is a table illustrating example output data in response to a query of collected collaboration data according to an example embodiment.

FIG. 5 is a block diagram of a framework where various parameters of interaction are passed as a report object according to an example embodiment.

FIG. 6 is an example of an output in response to a query of collected collaboration data according to an example embodiment.

FIG. 7 is a flow diagram illustration of a method of performing group assignment logic with the receiver according to an example embodiment.

FIG. 8 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software(e.g., an application, among others), firmware, or any combination of hardware, software, and firmware. The term, “logic” encompasses any functionality for performing a task. For instance, each operation illustrated in the flowcharts corresponds to logic for performing that operation, An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Raw collaboration data is collected from applications such as one or more of calendar, email, chat, and file sharing, to create a set of metrics to reveal such network structure, The collected collaboration data is run through heuristics to assign times to various collaborations. The assigned times are stored in a database and may be queried to show how much time teams spent within their own team versus with other teams. The database may be used to create group network visualization and to identify business problems, such as organization silos, as well as identifying costs of interactions within and outside an organization.

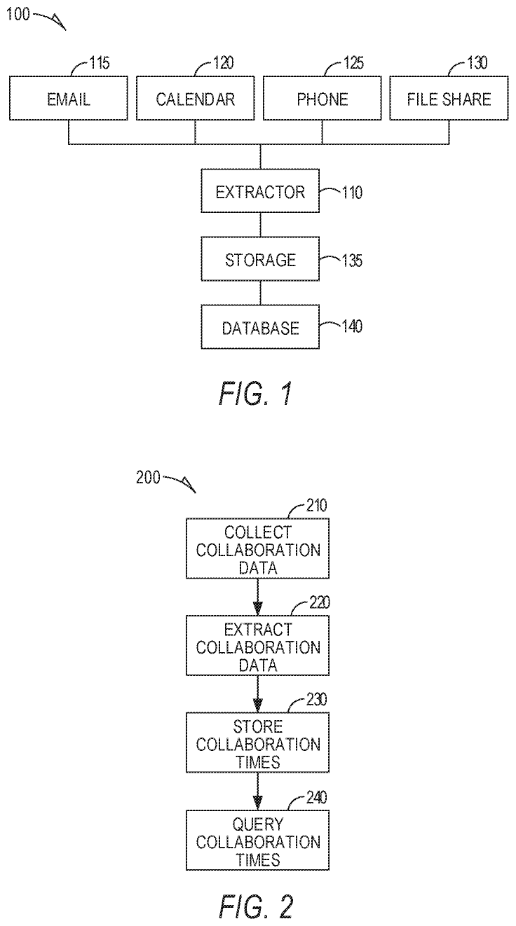

FIG. 1 is a block diagram of an example collaboration measurement and database system 100. System 100 includes a data extractor 110 that collects data from one or more collaborative systems, such as an email system 115, calendar system 120, phone system 125, and file share system 130. Each collaborative system, referred to as applications or apps, contains data regarding collaborative interactions. Raw data is obtained by extractor 110 including raw data regarding meetings, emails, chat, and file sharing (later referred to as “event”). Other data may also be collected, such as phone call data including data network-based calls, cellular network calls, and plain old telephone system calls in some embodiments.

The raw data contains person identification information and meta data about an event. In some embodiments, an individual's attribute data is combined with the raw event data to gain insights about each collaboration between or within the team. Organization data may also be collected from other systems as described below.

Metrics, referred to as collaboration times, are generated by processing the data using various heuristics by the extractor 110. The collaboration times and related organization data are stored in a storage 135. A database 140 may access storage 135 to perform queries on the collaborations times and related data.

The metrics include one or more of: Total collaboration hours—from investor team to other teams; Total meeting hours—this represent the time that the investor team has spent with the collaborator team; Total email hours; Total meeting count; Total email sent; Generated workload meeting hours; Generated workload meeting count; Generated workload email hours; and Generated workload email count.

The data collected from group collaboration applications or apps may be queried via database 140 to reveal facts about how teams communicate, which team is spending more time within their team versus other teams, how much more, which team is generating work on which team, which customers are consuming time and from which internal group, and many other facts about human resource utilization and collaboration.

System 100 may be used to identify how employees in the organization collaborates with others, both internally and externally. In modern workplaces, organizations provide various channels for communication to happen, such as emails, in person meetings, online meetings, instant message, file sharing and co-working in doc, etc. There's a significant amount of data that may be captured that can describe if employees are working together or not and who or what teams or groups are working together.

The database 140 can be used to help organizations solve business problems such as identifying local team silos in the organization, bringing visibility to balance cross team collaboration, and so on. The use of a groups resources can also be identified and used to adjust the amount of collaboration to desired levels or properly attribute costs.

In one embodiment, extractor 110 implements an algorithm that uses a notion of time givers, time receivers and exclusions from collaboration to provide better and accurate insights on time that groups of people invest in each other.

One of the questions the collaboration metrics is aiming to answer is if a group A is collaborating with other groups and how percentages of the collaboration time are allocated to each of the groups. The question would be easy to answer if group A only collaborates with one group at a time, but collaboration between groups is more complicated, and group A collaborates with more than one group at a time. Here is where the concept of time allocation comes into place. Time allocation is the logic used to define how the time of the members of group A that participated in each activity is distributed among the members of the different other groups that participated in the experience.

The key problem in answering the above question is to figure out who the time givers are, who the time receivers are, and who are neither of the two. The identification of givers and receivers may be used to provide insights on how much time a group spends with other groups. In one example, when a team meets for a brainstorming session each of the team members is generally giving every other team member an equal amount of time and receiving an equivalent amount of time from each of the team members. Assuming there are 4 people: A, B, C and D attending a meeting “M” of one hour. If there is equal participation from all 4 people one can say that A has given 20 minutes each to B, C, D and vice-versa. Hence each one of A, B, C and D have given one hour and have received one hour.

However, this formula of time allocation does not apply to all meetings. Assume A, B and C belong to sales organization of Company X, and D belongs to Purchasing organization of Company Y. In this case from the point of view of Company X, A, B, and C have given 3 hours to their customer Company Y and received one hour in return. This is because A, B and C, the employees who belong to sales organization of Company X are essentially not giving each other any time during the entire one hour of the meeting duration. They are each giving their one hour to the Customer, to D who is from purchasing organization of Company Y. If that fact is not considered, and an equal distribution of time is relied upon, then it appears that Company X has invested only 1 hour in Company Y in this meeting, whereas the reality is that Company X has invested 3 hours in Company Y in this meeting.

There is another group of people who impact the computation, ones who are neither time givers nor time receivers. In the above example, include an attendee E who is with company Z which is a partner sales channel for company X. From the point of view of company X, there is no change in the time invested that company X is making in company Y, irrespective of E being present or not. E here neither gives time to X, nor receives time from X.

Hence this notion of time giver, time receiver and exclusion (neither time receiver nor time giver) creates a differentiating algorithm that helps improve accuracy in computation of collaboration time spent between groups of people.

FIG. 2 is a flowchart illustrating a computer implemented method 200 of collecting, processing, and querying collaboration data. At operation 210, collaboration information containing data representative of collaborations between at least two individuals is collected. Time allocation heuristics are applied to the collected collaboration data at operation 220 to extract respective collaborations times for the at least two individuals. The extracted collaborations times are stored on a storage device at operation 230. Operation 240 accesses the storage device to process queries regarding collaboration between the at least two individuals.

In one embodiment, the collected collaboration data includes electronic calendar data identifying attendees and length of meetings. Email information for attendees from which organization data is extracted may also be collected. The collected collaboration data may include organization data, such as titles, email address, managers, departments, etc.

The time allocation heuristics in operation 220 may divide the time for conflicting meetings, allocating an external meeting more time than internal meeting for portions overlapping the internal meeting, as the individual may be presumed to be more likely to attend the external meeting. The proportion of time allocated to each of the conflicting meetings may be a fixed or adjustable percentage. The proportion may also be based on location information gleaned from one or more of facility access controls, cell phone location information, or other information identifying the location of the individual. For example, if the individual is outside an organization's building, or located at the place of the external meeting, all the time may be allocated to the external meeting.

Collected collaboration data may also include email data. Time allocation heuristics for email data may include length of time generating email and length of time reading email. The length of time may be obtained from an email system/application that measures actual time spent drafting or reading an email. If the actual time spent is not available, adjustable default times may be used, such as 2 minutes to read, 5 minutes to prepare. The times may be adjusted based on a length of the email in some embodiments. For example, an email with less than 100 words may be assigned a default time, with an email twice as long or longer being assigned twice the default time. A linear or nonlinear relationship between length and assigned length may be used in further embodiments.

In a further embodiment, collected collaboration data that identifies a likely individual may be eliminated from the storage to maintain privacy. For example, if an individual is in a small department, or has a manager that only manages a few people, such as less than 5 people, the data may be removed as likely to identify the individual.

In still further embodiments, the collected collaboration data may include chat data and file sharing data. Collaboration times extracted may be based on the length of a chat session or the amount of data in the chat session or the amount of time that individuals are working on a document in shared storage at the same time.

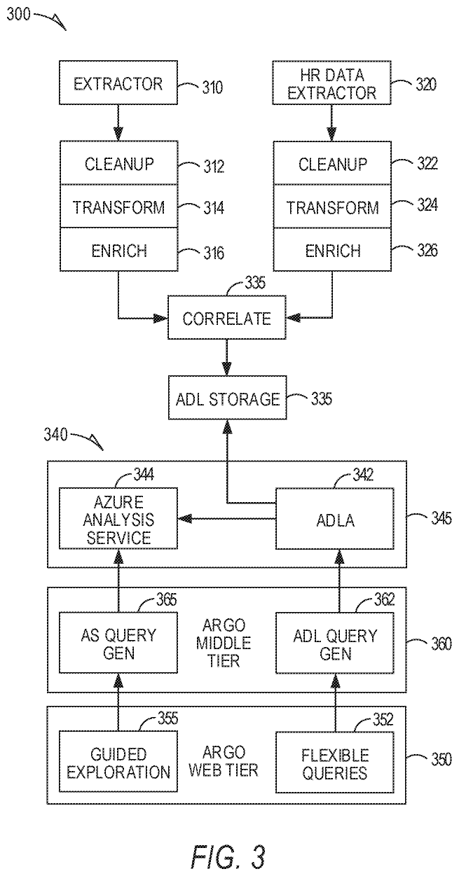

FIG. 3 is a block diagram illustrating details of an example collaboration measurement and database system 300. In one embodiment, a first data extractor 310 extracts data from a collaborative service, such as Microsoft Exchange. Other email and calendar applications and services may be used in further embodiments. In the case of Microsoft Exchange, raw o365 collaboration data is present on the exchange servers. A data pipeline starts with the extraction of this data. Metadata from emails may be extracted, including but not limited to from, to, cc, bcc, subject, attendees, accept, reject, tentative, etc. The extractor 310 may run at scale and provide privacy control supports. Privacy controls allow the exclusion of data that can be tied to an individual, or that includes sensitive data that an organization wishes to exclude from collaboration data. For example privacy control supports may include: don't extract mails with given keywords; don't extract mails and meetings of CEO; don't extract emails related to acquisitions; and other configurable filters.

Human resources (HR) data may also be collected via a second extractor 320. The HR data may include manager and org chart information, email addresses, levels, and titles of individuals, as well as other data that may be useful for determining collaborate times.

Extraction is followed by functions to cleanup 312, 322, transform 314, 324, and enrich 316, 326 the extracted collaboration and HR data with tenant provided metadata (HR, CRM (customer relationship management), etc.), The functions may be considered part of the extractors 310 and 320. The cleanup functions 312, 322 remove data related to selected individuals, such as the CEO, or emails with acquisition in the subject line. Other filters may be applied in further embodiments to excluded sensitive or undesired information,

The transform functions 314, 324 may be used to place the data into a canonical form to ensure consistency of the format of the data. The Enrich functions 316, 316 may be used to ensure conflicting data is handled. In one example, there may be meetings of an individual that overlap, and both were accepted. Heuristics may be applied to allocate time between the two meetings based on potential individual interest. External meetings would be allocated a higher percentage of the overlapping time than external meetings based on the assumption that an external meeting is more likely to have been attended.

The functions transform the extracted data into a form that is more easily usable for storing and querying. This can save considerable time and complexity when querying the data, as the functions are performed prior to the data being stored in a form suitable for querying. The functions may also prevent data that could be used to identify individuals or reveal sensitive data prior to it being stored in a form suitable for querying.

Additional data provided by one or more of the functions provides the ability to annotate Microsoft Office 365 data or data from other communication systems with key attributes for individuals participating in the collaboration interactions. These various data streams are merged at a correlate function 330. The correlate function 330 may be used to compare data with previous uploads to note changes in HR data, such as a new title, new manager, etc.

A single enriched view across datasets is created and stored at storage 335. Storage 335 may be Microsoft Azure Data Lake (ADL) storage in one embodiment, or other storage capable of providing data for querying by a database.

In one embodiment, a database service 340, such as ADL, query model provides a great deal of flexibility through Azure Data Lake Analytics (ADLA) service 342. ADLA service 342 may directly query storage 335, or may utilize an Azure Analysis Service 344, which contains pre-processed data, such indexes, tables, and other database structures to facilitate efficient servicing of queries, AMA 342 and service 344 are part of a query execution or runtime layer 345.

Queries of significant complexity which forms the time allocation logic can be converted to USQL (universal structured query language) and the runtime layer 345 being powered by Azure Data Lake (ADL) can chum through large amounts of raw data to generate the results. The query can take a few seconds to several minutes for the query to compiled, scheduled, executed and for the results to be returned. Results may be returned as CSV files or any other format which can be further processed before ready for consumption in common analytics tools (PowerBI, Excel, etc.).

Apart from flat file results, generated result's CSV for some specific scenarios are further loaded into azure analysis services 344 to provide interactive experience of querying.

A web interface tier 350 of the database service 340 may include user interfaces for a user to generate queries. A flexible query user interface 352 allows user to directly enter queries using one or more different query languages, such as structure sequence language (SQL). A guided exploration user interface 355 may be used to guide a user through query generation via several selection constructs as described in further detail below.

In a middle tier 360 of the database service 340, an ADL query generator 362 receives and processes queries from the flexible query user interface 352 and provides the processed queries to the ADL: 342 for either direct query of storage 335 or processing via service 344. An AS query generator 365 receives queries via the guided exploration user interface 355 and provides the queries to the service 344 for execution. The guided exploration user interface 355 in one embodiment, has structured queries that are formed based on the pre-processed data in service 344, constraining such queries to be satisfiable by the pre-processed data in service 344.

The extractors 110 and 310 perform time allocation heuristics/logic. The time allocation logic is designed to understand the collaboration patterns of a group of people with other groups and the intensity of the collaboration. The logic for the algorithms is based the following concepts:
In any activity, there is a group of people that gives time and a group of people that receives the time.
The group of people that we are evaluating their collaboration patterns is the giver of time and all the other people are the receivers of time.
The time given is calculated as the number of people in the giver group multiply by the “time of the activity” (people-hours)
The time given is evenly distributed among all the people in the activity that aren't in the giver team. If there nobody to allocate time to, the time is counted as a “Within Group” time.
In some cases, time should not be allocated to a specific group of people. To accomplish this, an exclusion group is defined. People in an exclusion group are treated as if they were not present in the activity.

The duration of an activity and how the duration is allocated is different depending on the type of activity:
For meetings, the time each person in the giver group contributes is their “adjusted” time for the meeting.
For email, two cases are considered:
   Write time
   Read time

If a member of the giver team is the sender, the write time will be evenly allocated among the recipients not in the giver group. If a member of the giver team is a recipient, the read time will be allocated to the sender.

The giver group (Group A) and receiver group (group B) are defined by a Filter and a Group By on people attributes. The Exclusion group is only defined by Filters.

The Group A is defined by the filters definition and by each of the values in the group by. If the group by is selected, there will be N group As, one for each of the group by attribute values and the filter. For instance, if the filter is: Location=SEA and the group by is “role” where the “Role” values can be “PM, Dev, Sales”. There will be 3 group A:
Group A 1: Location=SEA and Role=PM
Group A 1: Location=SEA and Role=Dev
Group A 1: Location=SEA and Role=Sales

The same applies for Group B. Since the groups are defined by attributes and each group can be defined by different attributes the groups can overlap but a person should be considered only member of one of the groups. If an overlap occurs, we will use the following priority to decide to which group the person belongs: Group A (giver), group B (receiver) (filter only), exclusion.

For example: If the analyst wants to understand how the different disciplines in Org A interact with the PM in the other regions but not the NYC region, the analyst will select:
Group A: Filter: Organization=Org A and Group By discipline.
Group B: Filter: Discipline=PM and Group by Location.
Exclusion: Location=NYC

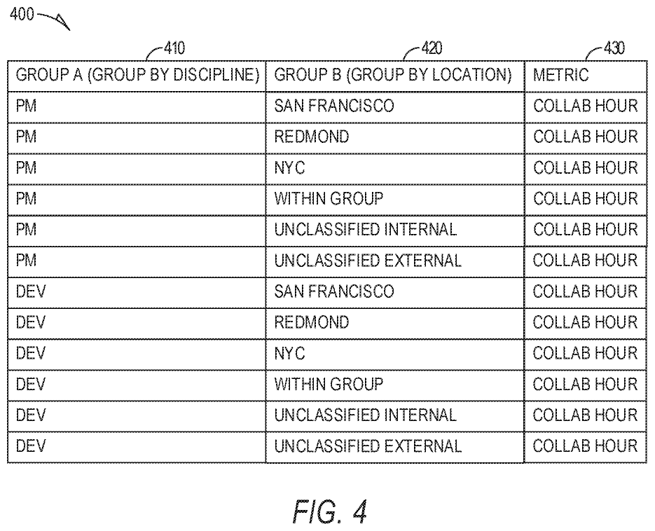

In the example above the output data will look like: If discipline has two values: PM and Dev and Location has three values: Redmond, San Francisco and New York. The query result table will look like Table 400 in FIG. 4. Group A results are in the first column 410 with grouped by discipline values of PM and Dev. Group B results are in the second column 420 grouped by location. The metric is in the third column 430 according to collaboration hour.

A pseudo code snippet for time allocation for a meeting follows:

ProjectedPeoplePerMeeting = FETCH MeetingId, StartDate, TimeGiver,
IsNamedTimeReceiver, ExcludedReceiver, GiverGroup,
NamedReceiverGrouping, DurationHours_Adj

FROM MeetingInfo & HRData
WHERE (meetingFilter && Datefilter && (GiverFilter | |

ReceiverFilter | | ExclusionFilter))
MeetingStatistics = FETCH MeetingId, StartDate, TotalReceivers

FROM ProjectedPeoplePerMeeting
GROUPING ON MeetingId, StartDate

MeetingBreakdownStatistics = FETCH MeetingId, StartDate,
IsTimeGiver, GiverGrouping,
ReceiverGrouping, NumberOfReceivers, SUM(ppl.GivenTime) AS
TotalGivenTime

FROM PeoplePerMeetingCleaned
GROUPING ON MeetingId, StartDate, IsTimeGiver,

GiverGrouping, ReceiverGrouping
PreTimeAllocatedMeetings = FETCH MeetingId, StartDate,
PreAllocatedTime, NumberOfGiversProxy, GiverGrouping,
ReceiverGrouping

FROM MeetingBreakdownStatistics &&

MeetingBreakdownStatistics

WHERE givers.IsTimeGiver

CollectedMeetingPreAllocations = FETCH MeetingId, StartDate,
GiverGrouping, ReceiverGrouping,
PreAllocatedTime, NumberOfGiversProxy

FROM PreTimeAllocatedMeetings
GROUPING ON MeetingId, StartDate, GiverGrouping,

ReceiverGrouping
TimeAllocatedMeetings = FETCH GiverGrouping, ReceiverGrouping,
StartDate, Allocation

FROM CollectedMeetingPreAllocations && MeetingStatistics

TimeAllocationMeetingsResult = FETCH GiverGrouping,

| | |
|---|---|
| ReceiverGrouping, cadence, SUM(Allocations) | FROM |

TimeAllocatedMeetings

The following is a pseudo code snippet for the time allocation logic for Mail:

ProjectedPeoplePerMail = FETCH mailInfo, TheTimeGiver,
TheTimeReceiver, GiverGroup,
ReceiverGroup, FROM Mail And HRData WHERE (Datefilter &&

| | |
|---|---|
| (GiverFilter \| \| | ReceiverFilter \| \| |

ExclusionFiiter));
MailStatistics = FETCH MailInfo, TotalTimeReceivers FROM

| | |
|---|---|
| ProjectedPeoplePerMail Grouping On | ExchangeId, |

Date
MailBreakdownStatistics = FETCH ExchangeId, StartDate, GiverGroup,
ReceiverGroup, MailTimeInfo

NumberOfSenderTimeReceivers
FROM MailStatistics
Grouping Exchange, Date, Giver Group and Receiver Group

PreTimeAllocatedMails = FETCH ExchangeId, StartDate, GiverGroup,
ReceiverGroup, excludedRecipient,

ImputedTime, PreAllocatedReceiverTime
FROM MailBreakdownStatistics AND Mailstatistics

CollectedMailPreAllocations = FETCH ExchangeId, startDate,
GiverGroup, ReceiverGrouping,

SUM(PreAllocatedSenderTime), RecepientsToExclude
ImputedTimeSum, PreAllocatedReceiverTime
FROM PreTimeAllocatedMails
GROUPING ON Exchange, Date, Giver Group and Receiver

```
Group
TimeAllocatedMails = FETCH Giver Group, Receiver Group, Date,
ImputedTime,
  ReceiverAllocatio FROM CollectedMailPreAllocations
TimeAllocationMailsResult = FETCH Giver Group, Receiver Group, Date
  SUM(SenderAllocation, ReceiverAllocation, ImputedTime) AS
MailTimeAllocation
  FROM TimeAllocation
```

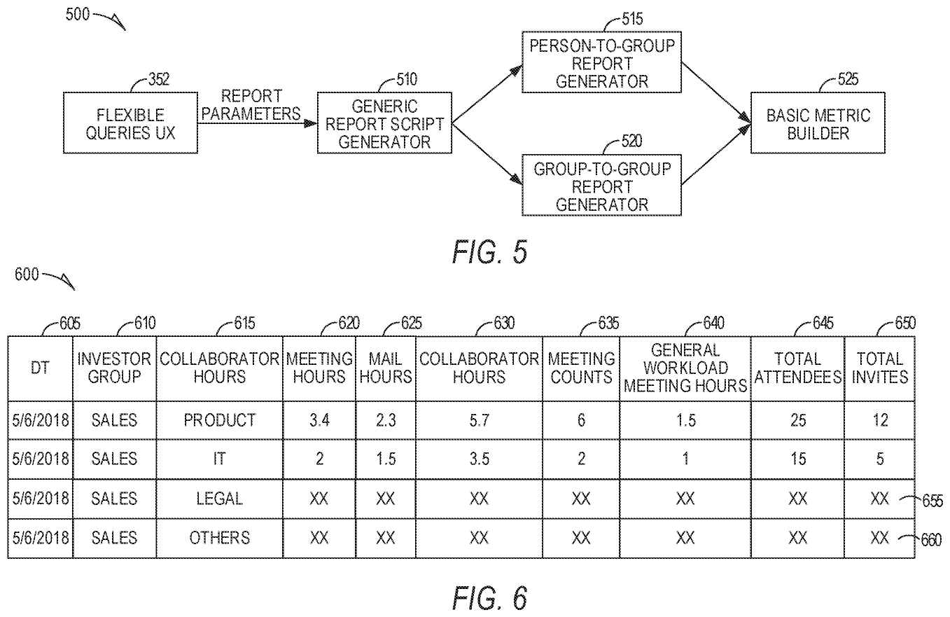

FIG. 5 is block diagram of a framework 500 where various parameters of interaction between two entities X and Y are passed as a Report object from frontend to backend. A query may be generated via the flexible query user interface 352. Each entity could be a person or a group of persons. So, these interactions could be of type: PersonToGroup generator 515, GroupToPerson or GroupToGroup generator 520. The common logic for each of these report generators 515 and 520 captured within generic report script generator 510. Each report generator 515, 520 then calls a metric builder 525 which translates the actual logic into USQL scripts.

In one embodiment, a first step is to find all the possible groupings for each participant for each meeting/mail they satisfy: TimeGiver, TimeReceiver, and Excluded. Then people that are Excluded and are neither a TimeGiver nor a TimeReceiver are filtered out. Groupings from the previous step are cleaned up further: zero out meeting/mail time for people who are not TimeGivers and assign appropriate TimeReceiver Group to each attendee. Total number of potential time receivers is calculated. For each group of people, amount of time they have the potential to give is calculated. The persons which are part of both givers and receivers group are called proxy receivers. This number is subtracted from the total number of potential time receivers when this group is the TimeGiver.

For each pair of Time Giver/Time Receiver, the number of receivers is calculated. For the case where TimeGivers are equal to TimeReceivers, TimeReceiver grouping is set to “Within Group”. All time allocations per TimeGiver/TimeReceiver combination across all meetings/mails for the given cadence is summed up to generate results.

In a further embodiment, the collaboration time data may be queried to answer how employees in the organization collaborate with others, both internally and externally. In modern workplace, organizations provide various channels for communication to happen, such as emails, in person meetings, online meetings, instant message, file sharing and co-working in doe, etc. There's a significant amount of data captured which can describe if employees are working together or not, who and who are working together. A set of metrics is created using this type of collaboration data. The metrics can be used to help organizations to solve business problems such as local team silos in the organization, bring visibility to balance cross team collaboration, and for other management purposes.

To describe how teams collaborate in the company, teams may be differentiated by investor teams and collaborator teams. An investor team is the team that spends time with the collaborator teams. For example, for a meeting between 3 persons from Sales team and 1 person a Finance team. From the Sales team's perspective, they have invested 3 person-hours to Finance team. From the Finance team's perspective, they have invested 1-person hour to Sales team in this meeting.

A collaborate team is the team who has received time from the investor teams. A collaborator team can also be an investor team. for example, in the meeting above, the Sales and Finance teams both have received time from each other.

With employees' collaboration data and certain FIR attributes such as team information, many metrics may be calculated. Meeting hours is the meeting duration that one internal group (investor group) has spent with people in another group (Collaborators group). This metric uses time allocation logic.

Email hours are the hours that the investor group has spent in the emails (send and read) with people in the Collaborators group. This metric uses time allocation logic.

Total collaboration hours are sums of meeting hours and email hours between investor group and collaborator group.

Meeting count is the count of unique meetings where the investor group attended with one or more people in the collaborators group.

Generated workload meeting hours are the sum of meeting hours that one group has scheduled with another group.

Total attendees is the sum of the count of all attendees where at least one attendee or organizer is from each group.

Total invitees SUMS the count of all invitees where at least one invitee or organizer is from each group.

Allocation of time is calculated in one embodiment using the following logic.

| Meeting hours | This metric allocates time based on the attribute | |
|---|---|---|
| | selected to group Time Investors and Collaborators: | |
| | 1) | For each meeting, distribute time investor group's |
| | | time (total of attendees time) proportionally to the |
| | | collaborator groups (no matter they're measured |
| | | employee, or unmeasured employee, or external |
| | | people). |
| | | E.g. for an 1 hour meeting with 2 measured |
| | | employee from Engineering, 2 employees |
| | | from Sales, 1 from Marketing. The |
| | | Engineering team allocates 2 hours toward |
| | | other teams. The 2 hours is distributed |
| | | proportionally to Sales and Marketing, |
| | | based on their headcount presents - 2/3 to |
| | | Sales (2 hr * 2/3 = 4/3 hrs), and 1/3 to |
| | | Marketing (2 hr * 1/3 = 2/3 hrs) |
| | | If there're people excluded by “Limit |
| | | Population”, exclude them from the attendee |
| | | set first. |
| Email hours | This metric allocates time based on the attribute | |
| | selected to group Time Investers and Collaborators: | |
| | 1) For each sent email, distribute time investor | |
| | group's email sent time (sender's time) proportionally | |
| | to the collaborator groups (no matter they're | |
| | measured employee, or unmeasured employee, or | |
| | external people). | |
| | 2) For each read email, use the read hours as the time | |
| | the recipient (investor) has spent with the sender | |
| | (collaborator). | |
| | | if mail is sent to non-measured employee |
| | | then impute a read time for the sender which |
| | | is 0.5 * SenderTime. |

| | |
|---|---|
| Total | Collaboration Hours is a sum of Meeting hours and |
| collaboration | Mail hours per investor group, collaborator group, |
| hours | dt. |
| Meeting count | Sums the count of all unique meetings where at |
| | least one attendee or organizer is front each group |
| Generated | Group-generated workload meeting hours doesn't use |
| workload | time allocation. It takes the person metric, group by |
| meeting hours | certain person attribute. If sum this metric up, this |
| | should equal to the “generated workload meeting |
| | hours” in person query. |
| Total attendees | Sums the count of all attendees where at least one |
| | attendee or organizer is from each group. “Attendee” |
| | is defined by not decline the meeting. |
| Total invitees | Sums the count of all invitees where at least one |
| | invitee or organizer is from each group. |

FIG. 6 is an example of an output 600. Columns in this example are selectable, and include data 605, investor group 610, collaborate group 615, meeting hours 620, email hours 625, collaboration hours 630, meeting count 635, generated workload meeting hours 640, total attendees 645, and total invitees 650. There are four rows for events that occurred on May 6, 2018 involving the Sales group as the investor group, and different collaborator groups including Products, IT, Legal, and Others. Note that the last two rows 655, 660 do not include data in the hours type columns, as they have been excluded based on exclusion filters.

Internal bucket will have the people who pass the receiver filter (if applied) and don't have value for the HR attribute on which receiver are grouped upon. Assign internal attendees who (may or may not) have HR attributes but not matching the receiver filter to “Other internal”. Other internal bucket will have the internal peoples who does not pass the receiver filter (if applied) and may or may not have value for the FIR attribute on which receiver are grouped upon.

### Definition in Slides

Internal—Assign internal attendees who don't have FIR attributes.
Other internal—Assign internal attendees who have HR attributes but not matching the filter.

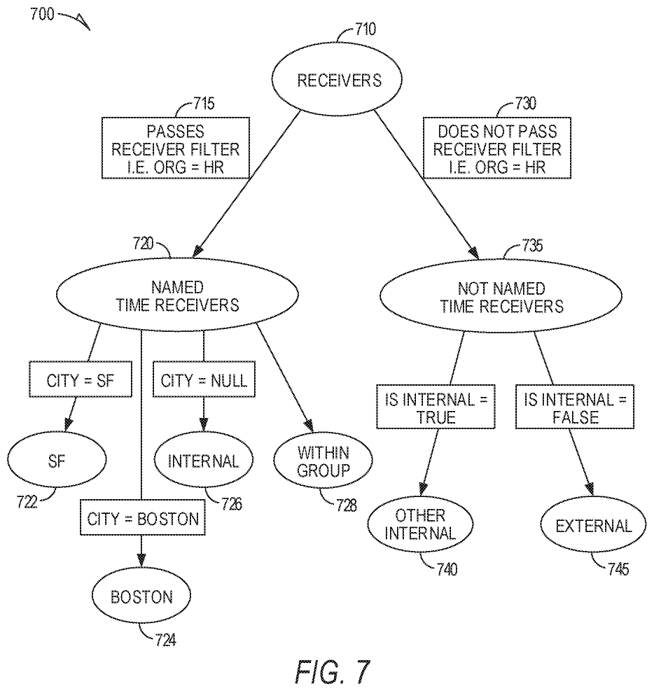

FIG. 7 is a flow diagram illustration of a method 700 of performing group assignment logic with the receiver groupBy:city and filtering upon org=HR. Receivers are received at operation 710. HR organization filters are applied as indicated at 715 and 730, with filter 715 passing receivers that are identified with the HR organization. Filter 730 passes receivers that are not identified with the HR organization. At 720, receivers that passed filter 715 are identified as named time receivers, and their locations are identified as SF 722, Boston 724, Internal 726, or WithinGroup 728. Receivers that were filtered and passed by filter 730 are identified as not named time receivers at 735, and if they are identified as internal=true, they are identified as Other Internal. If internal=false, the receiver is identified as External at 745.

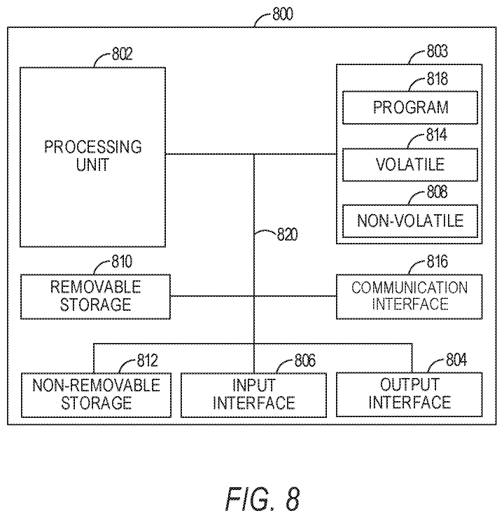

FIG. 8 is a block schematic diagram of a computer system 800 to implement collaboration data collection, processing, storage, and querying and for performing methods and algorithms according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8, Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be nm, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular. Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more systems to collect collaboration information, apply time allocation heuristics to extract collaboration times, store the extracted times in a database, and process queries. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 818 along with the workspace manager 822 may be used to cause processing unit 802 to perform one or more methods or algorithms described herein.

### EXAMPLES

1. A computer implemented method comprising collecting collaboration information containing data representative of collaborations between at least two individuals, applying time allocation heuristics to the collected collaboration data to extract respective collaborations times for the at least two individuals, storing the extracted collaborations times on a storage device, and accessing the storage device to process queries regarding collaboration between the at least two individuals.

2. The method of example 1 wherein collected collaboration data includes electronic calendar data identifying attendees and length of meetings.

3. The method of any of the previous examples wherein collected collaboration data includes email information for attendees from which organization data is extracted.

4. The method of any of the previous examples wherein collected collaboration data includes organization data selected from the group consisting of titles, email address, managers, and departments.

5. The method of any of the previous examples wherein time allocation heuristics divide time for conflicting meetings.

6. The method of any of the previous examples wherein time allocation heuristics allocate more time for external meetings that conflict with internal meetings.

7. The method of any of the previous examples wherein collected collaboration data includes email data.

8. The method of any of the previous examples wherein collected collaboration data includes length of time generating email and length of time reading email.

9. The method of example 8 wherein the collaboration data for emails is obtained from email system and is representative of actual time spent drafting and reading emails.

10. The method of any of the previous examples and further comprising eliminating collected collaboration data that identifies a likely individual to maintain privacy.

11. A machine-readable storage device having instructions for execution by a processor of a machine to cause the processor to perform operations to perform a method of managing communication accounts, the operations comprising collecting collaboration information containing data representative of collaborations between at least two individuals, applying time allocation heuristics to the collected collaboration data to extract respective collaborations times for the at least two individuals, storing the extracted collaborations times on a storage device, and accessing the storage device to process queries regarding collaboration between the at least two individuals.

12. The device of example 11 wherein collected collaboration data includes electronic calendar data identifying attendees and length of meetings.

13. The device of any of the previous examples wherein collected collaboration data includes email information for attendees from which organization data is extracted.

14. The device of any of the previous examples wherein collected collaboration data includes organization data selected from the group consisting of titles, email address, managers, and departments.

15. The device of any of the previous examples wherein time allocation heuristics divide time for conflicting meetings.

16. The device of any of the previous examples wherein time allocation heuristics allocate more time for external meetings that conflict with internal meetings.

17. The device of any of the previous examples wherein collected collaboration data includes email data.

18. The device of any of the previous examples wherein collected collaboration data includes length of time generating email and length of time reading email.

19. The device of example 18 wherein the collaboration data for emails is obtained from email system and is representative of actual time spent drafting and reading emails.

20. The device of any of the previous examples and further comprising eliminating collected collaboration data that identifies a likely individual to maintain privacy.

21. A device includes a processor and a memory device coupled to the processor and having a program stored thereon for execution by the processor to perform operations comprising collecting collaboration information containing data representative of collaborations between at least two individual, applying time allocation heuristics to the collected collaboration data to extract respective collaborations times for the at least two individuals, storing the extracted collaborations times on a storage device, and accessing the storage device to process queries regarding collaboration between the at least two individuals.

22. The device of example 21 wherein collected collaboration data includes electronic calendar data identifying attendees and length of meetings.

23. The device of any of the previous examples wherein collected collaboration data includes email information for attendees from which organization data is extracted.

24. The device of any of the previous examples wherein collected collaboration data includes organization data selected from the group consisting of titles, email address, managers, and departments.

25. The device of any of the previous examples wherein time allocation heuristics divide time for conflicting meetings.

26. The device of any of the previous examples wherein time allocation heuristics allocate more time for external meetings that conflict with internal meetings.

27. The device of any of the previous examples wherein collected collaboration data includes email data.

28. The device of any of the previous examples wherein collected collaboration data includes length of time generating email and length of time reading email.

29. The device of example 28 wherein the collaboration data for email s is obtained from email system and is representative of actual time spent drafting and reading emails.

30. The device of any of the previous examples and further comprising eliminating collected collaboration data that identifies a likely individual to maintain privacy.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
collecting collaboration information containing collaboration data representative of collaborations between at least two individuals;
applying time allocation heuristics to the collected collaboration data to extract respective collaborations times for the at least two individuals;
storing the extracted collaborations times on a storage device; and
accessing the storage device to process queries regarding collaboration between the at least two individuals.

2. The method of claim 1 wherein collected collaboration data includes electronic calendar data identifying attendees and length of meetings.

3. The method of claim 1 wherein collected collaboration data includes email information for attendees from which organization data is extracted.

4. The method of claim 1 wherein collected collaboration data includes organization data selected from the group consisting of titles, email address, managers, and departments.

5. The method of claim 1 wherein time allocation heuristics divide time for conflicting meetings.

6. The method of claim 5 wherein time allocation heuristics allocate more time for external meetings that conflict with internal meetings.

7. The method of claim 1 wherein collected collaboration data includes email data.

8. The method of claim 7 wherein collected collaboration data includes length of time generating email and length of time reading email.

9. The method of claim 8 wherein the collaboration data for emails is obtained from email system and is representative of actual time spent drafting and reading emails.

10. The method of claim 1 and further comprising eliminating collected collaboration data that identifies a likely individual to maintain privacy.

11. A machine-readable storage device having instructions for execution by a processor of a machine to cause the processor to perform operations to perform a method of managing communication accounts, the operations comprising:
collecting collaboration information containing collaboration data representative of collaborations between at least two individuals;
applying time allocation heuristics to the collected collaboration data to extract respective collaborations times for the at least two individuals;
storing the extracted collaborations times on a storage device; and
accessing the storage device to process queries regarding collaboration between the at least two individuals.

12. The device of claim 11 wherein collected collaboration data includes electronic calendar data identifying attendees and length of meetings, email information for attendees from which organization data is extracted, and organization data selected from the group consisting of titles, email address, managers, and departments.

13. The device of claim 12 wherein time allocation heuristics divide time for conflicting meetings and wherein time allocation heuristics allocate more time for external meetings that conflict with internal meetings.

14. The device of claim 12 wherein collected collaboration data includes email data including length of time generating email and length of time reading email.

15. The device of claim 14 wherein the collaboration data for mails is obtained from email system and is representative of actual time spent drafting and reading emails.

16. The device of claim 11 and further comprising eliminating collected collaboration data that identifies a likely individual to maintain privacy.

17. A device comprising:
a processor; and
a memory device coupled to the processor and having a program stored thereon for execution by the processor to perform operations comprising:
collecting collaboration information containing collaboration data representative of collaborations between at least two individuals;
applying time allocation heuristics to the collected collaboration data to extract respective collaborations times for the at least two individuals;
storing the extracted collaborations times on a storage device; and
accessing the storage device to process queries regarding collaboration between the at least two individuals.

18. The device of claim 17 wherein collected collaboration data includes electronic calendar data identifying attendees and length of meetings, email information for attendees from which organization data is extracted, and organization data selected from the group consisting of titles, email address, managers, and departments, and wherein time allocation heuristics divide time for conflicting meetings and wherein time allocation heuristics allocate more time for external meetings that conflict with internal meetings.

19. The device of claim 17 wherein collected collaboration data includes email data including length of time generating email and length of time reading email, and wherein the collaboration data for emails is obtained from email system and is representative of actual time spent drafting and reading emails.

20. The device of claim 17 and further comprising eliminating collected collaboration data that identities a likely individual to maintain privacy.
